(19) United States
(12) Patent Application Publication
(10) Pub. No.: US 2024/0256530 A1
(43) Pub. Date: Aug. 1, 2024

(54) DIFFERENTIALLY PRIVATE APPROXIMATE DISTINCT-COUNTING SKETCHES

(71) Applicant: Meta Platforms, Inc., Menlo Park, CA (US)

(72) Inventors: Jonathan Hehir, Redmond, WA (US); Graham Cormode, Coventry (GB); Daniel Ting, Shoreline, WA (US)

(21) Appl. No.: 18/104,119

(22) Filed: Jan. 31, 2023

(51) Int. Cl. G06F 16/242; G06F 16/25

(52) U.S. Cl. CPC G06F 16/244; G06F 16/254

(57) ABSTRACT

A system for determining and merging differentially private approximate distinct-counting sketches is disclosed. A first non-private probabilistic cardinality estimator for a first dataset is determined. The first non-private probabilistic cardinality estimator is converted to a first private probabilistic cardinality estimator for the first dataset with a first noise level. The first private probabilistic cardinality estimator for the first dataset is merged with a second probabilistic cardinality estimator for a second dataset with a second noise level to produce a merged probabilistic cardinality estimator for the first dataset and the second dataset combined together based at least in part on the first noise level and the second noise level. A number of unique elements in the first dataset and the second dataset combined together is estimated based on the merged probabilistic cardinality estimator for the first dataset and the second dataset combined together.

### BACKGROUND OF THE DISCLOSURE

Many applications that model large volumes of data are based on tracking cardinalities of events or observations. Consequently, these applications make extensive use of data sketches that support fast, approximate cardinality estimation. At the expense of a small estimation error, these approximate methods drastically reduce the computational cost of distinct-counting to run in linear time, using only bounded memory. An additional key feature of distinct-count sketches is the ability to merge two or more sketches to obtain cardinality estimates over their union. This enables not only distributed computation, but also many rich aggregation possibilities from previously computed sketches. As a result, modern data pipelines rely extensively on the performance and functionality of such cardinality sketches.

### BRIEF DESCRIPTION OF THE DRAWINGS

Various embodiments of the disclosure are disclosed in the following detailed description and the accompanying drawings.

FIG. 1 illustrates an exemplary system 100 that includes a private distinct-counting sketching system 108 for estimating a number of distinct elements.

FIG. 2 illustrates an exemplary process 200 for determining a number of distinct elements in two or more datasets.

FIG. 3 illustrates an exemplary PCSA sketch 300 with a B×P matrix of bits, where B is the number of buckets, and P is a measure of precision.

FIG. 4 illustrates an exemplary PCSA sketch 400 after 50,000 unique items have been added to PCSA sketch 300.

FIG. 5 illustrates an exemplary process 500 for randomizing the non-private probabilistic cardinality estimator using a deterministic-merge randomized response.

FIG. 6 illustrates an exemplary private sketch 600 after randomization of the PCSA sketch 400 using the deterministic-merge randomized response with q₁=2.5%.

FIG. 7 illustrates an exemplary process 700 for randomizing the non-private probabilistic cardinality estimator using a randomized-merge response.

FIG. 8 illustrates an exemplary private sketch 800 after randomization of all bits of the PCSA sketch 400 using the randomized-merge response with q₂=4.7%.

FIG. 9 illustrates an exemplary process 900 for merging a private sketch for a first dataset with another private sketch to produce a merged sketch for the combined datasets.

FIG. 10 illustrates an example of merging two private sketches that have been randomized using the deterministic-merge randomized response to produce a merged private sketch.

FIG. 11 illustrates an exemplary table 1100 for determining the merged bits of two sketches (X and Y) that have been randomized using the randomized-merge response.

FIG. 12 illustrates an example of merging two private sketches that have been randomized using the randomized-merge response to produce a merged private sketch.

FIG. 13 is a functional diagram illustrating a programmed computer system for executing some of the processes in accordance with some embodiments.

### DETAILED DESCRIPTION

The disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

Data sketching is a critical tool for distinct-counting, enabling multisets to be represented by compact summaries that admit fast cardinality estimates. Because these sketches may be merged to summarize multiset unions, they are a basic building block in data warehouses.

Increasingly, though, privacy concerns constrain the operation of data processing. Regulations and organization-specific commitments to privacy require that data collected from individuals be subject to appropriate mitigations before being passed to downstream processing. Specifically, protections such as differential privacy are required to protect sensitive data while still giving accurate query response.

Although sketching techniques that apply randomly-chosen transformations to reduce data may appear to offer some protection, it is well-known that sketching alone does not automatically provide a privacy guarantee. The summaries—or even the estimates calculated from them—can leak considerable information about the specific items that do or do not belong to the underlying set. Recently, it has been shown that the contents of sketches do meet a privacy standard if the associated hash functions are not known to the observer. However, it is not plausible to assume secret hash functions when the computation is shared among multiple entities in a large scale system. In particular, the hash function has to be known to all participants when working with sketches that will be merged (e.g., between different advertisers who are collating information on the number of distinct users who are exposed to a particular campaign). This creates an important gap to make these high-throughput systems private. Previous attempts to construct privacy-preserving sketches generally do not offer practical means of merging sketches. Rather, in several cases they place assumptions on the secrecy and randomness of the hash function that preclude merging altogether.

In the present application, improved techniques for constructing mergeable and differentially private (DP) cardinality sketches by pairing randomized responses with carefully designed merge operations and cardinality estimation are disclosed. While most existing DP sketches do not support merging, the present application discloses different embodiments for constructing private, mergeable sketches, including a novel randomized technique for performing logical operations on noisy bits. Through a combination of improved estimation, merging, and privacy analysis, the improved sketches dramatically outperform existing solutions in simulations and on real-world data.

The present application discloses a practical, mergeable, and provably private approach to distinct-count sketching. In particular, the improved sketches satisfy the strong definition of ε-differential privacy (DP) even when the hash function is known publicly. By attaching the privacy guarantee to the sketch itself, not just the cardinality estimate, sketches corresponding to sensitive multisets may be safely released, thereby enabling safe cardinality estimation over any union of such sets using the privacy-preserving sketches in lieu of the original sensitive data.

In the present application, a system for determining and merging differentially private approximate distinct-counting sketches is disclosed. A first non-private probabilistic cardinality estimator for a first dataset is determined. The first non-private probabilistic cardinality estimator is converted to a first private probabilistic cardinality estimator for the first dataset with a first noise level. The first private probabilistic cardinality estimator for the first dataset is merged with a second probabilistic cardinality estimator for a second dataset with a second noise level to produce a merged probabilistic cardinality estimator for the first dataset and the second dataset combined together based at least in part on the first noise level and the second noise level. A number of unique elements in the first dataset and the second dataset combined together is estimated based on the merged probabilistic cardinality estimator for the first dataset and the second dataset combined together.

A method for determining and merging differentially private approximate distinct-counting sketches is disclosed. A first non-private probabilistic cardinality estimator for a first dataset is determined. The first non-private probabilistic cardinality estimator is converted to a first private probabilistic cardinality estimator for the first dataset with a first noise level. The first private probabilistic cardinality estimator for the first dataset is merged with a second probabilistic cardinality estimator for a second dataset with a second noise level to produce a merged probabilistic cardinality estimator for the first dataset and the second dataset combined together based at least in part on the first noise level and the second noise level. A number of unique elements in the first dataset and the second dataset combined together is estimated based on the merged probabilistic cardinality estimator for the first dataset and the second dataset combined together.

A computer program product embodied in a non-transitory computer readable medium and comprising computer instructions for determining and merging differentially private approximate distinct-counting sketches is disclosed. A first non-private probabilistic cardinality estimator for a first dataset is determined. The first non-private probabilistic cardinality estimator is converted to a first private probabilistic cardinality estimator for the first dataset with a first noise level. The first private probabilistic cardinality estimator for the first dataset is merged with a second probabilistic cardinality estimator for a second dataset with a second noise level to produce a merged probabilistic cardinality estimator for the first dataset and the second dataset combined together based at least in part on the first noise level and the second noise level. A number of unique elements in the first dataset and the second dataset combined together is estimated based on the merged probabilistic cardinality estimator for the first dataset and the second dataset combined together.

One traditional distinct-count sketching technique is the probabilistic counting with stochastic averaging (PCSA). A few subsequently developed techniques enhanced the performance of PCSA (non-privately) and optimized the memory space usage. These techniques include LogLog and HyperLogLog sketches and their variants. However, reducing the memory space makes these sketches less amenable to privacy protection: small changes to the input can cause big changes in the summary, which entails more noise addition, and therefore yielding less accurate results. In contrast, the PCSA sketch is particularly suited to privacy preservation because it stores a summary of all hash values observed, rather than relying on sets of extreme hash statistics. Moreover, due to the simple binary structure of the PCSA sketch, the improved privacy mechanism and merging operations disclosed in the present application generalize to additional sketches and settings beyond PCSA.

Different embodiments for constructing DP cardinality sketches and obtaining cardinality estimates are disclosed. Some embodiments use a deterministic bit-merging operation and a randomized response. Some embodiments use an improved randomized merge that allows for up to 75% variance reduction over the deterministic-merge variant. These results generalize to arbitrary bitwise operations on binary data. Applying the improved techniques to PCSA sketches, an efficient likelihood-based estimator for cardinality is used. Along with tight privacy analysis, the improved techniques provide significant improvement over existing methods and show a precise quantitative tradeoff between mergeability and privacy.

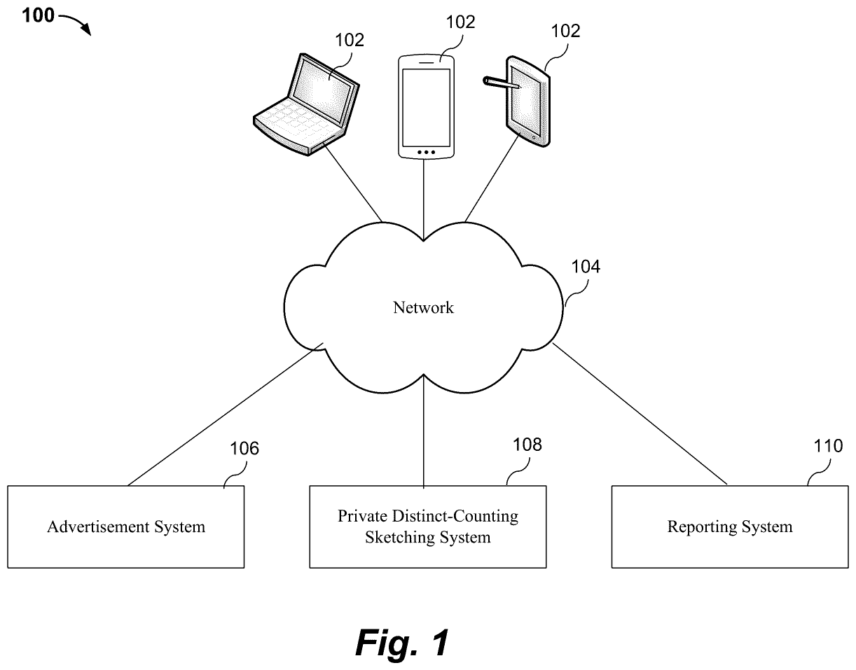

FIG. 1 illustrates an exemplary system 100 that includes a private distinct-counting sketching system 108 for estimating a number of distinct elements. In this exemplary system 100, private distinct-counting sketching system 108 is used to determine the number of unique users who have seen a specific advertisement over a specified time period. However, it should be recognized that private distinct-counting sketching system 108 may be used to determine the number of unique users who have sent messages on a social network over a specified time period, the number of unique users that have accessed an online application or website over a specified time period, the number of IP addresses of packets passing through a router, the number of elements in a database, and the like.

As shown in FIG. 1, system 100 includes a plurality of users 102, a network 104, an advertisement system 106, a private distinct-counting sketching system 108, and a reporting system 110. A user 102 may be a user using any device, including laptop computers, desktop computers, tablet computers, smartphones, and other mobile devices. The users 102 are connected to advertisement system 106 through network 104. Network 104 may be any combination of public or private networks, including intranets, local area networks (LANs), wide area networks (WANs), radio access networks (RANs), Wi-Fi networks, the Internet, and the like. Advertisement system 106 may be connected to private distinct-counting sketching system 108 through network 104. Private distinct-counting sketching system 108 may be connected to reporting system 110 through network 104.

When a user 102 clicks on an advertisement, an event is sent to the advertisement system 106. Advertisement system 106 may send a command to private distinct-counting sketching system 108 with different information, including the campaign ID, the received date of the event from user 102, and the user ID associated with user 102, to indicate to private distinct-counting sketching system 108 that user 102 has viewed the advertisement of the campaign. Private distinct-counting sketching system 108 receives the commands collected from the plurality of users 102 over time, estimates the number of unique users 102 who have seen a specific advertisement over a specified time period, and sends the results to reporting system 110.

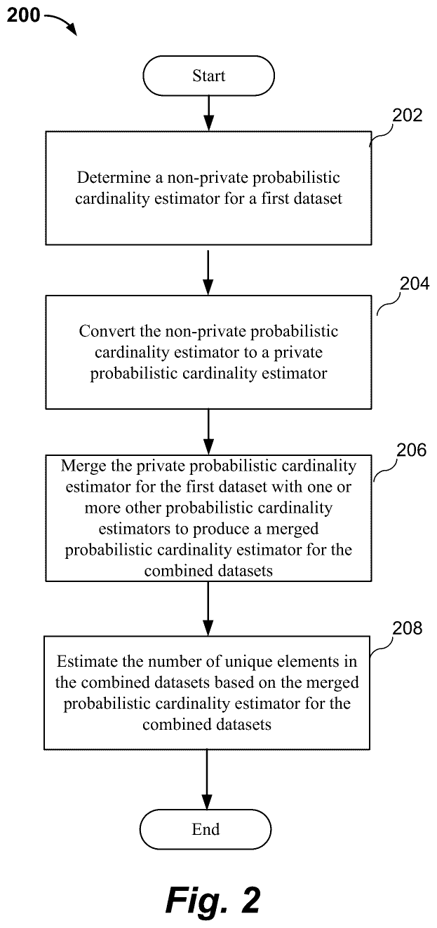

FIG. 2 illustrates an exemplary process 200 for determining a number of distinct elements in two or more datasets. Process 200 creates differentially private data sketches for cardinality estimation. It creates scalable, privacy-preserving data summaries that are useful for counting unique elements in large datasets. In some embodiments, process 200 is performed by at least some components of system 100, including private distinct-counting sketching system 108.

As shown in FIG. 2, at step 202, a non-private probabilistic cardinality estimator for a first dataset is determined first. Calculating the exact cardinality of the distinct elements of a multiset requires an amount of memory proportional to the cardinality, which is impractical for very large data sets. Memory-efficient probabilistic cardinality estimators may be used to obtain an approximation of the cardinality. Probabilistic sketching data structures store a summary of a data set in situations where the whole data would be prohibitively costly to store. In some embodiments, the non-private probabilistic cardinality estimation is based on the non-private probabilistic counting with stochastic averaging (PCSA) sketch. Creating the non-private sketch transforms a dataset into a small summary taking the form of a matrix of bits. In the non-private setting, this sketch can be used to estimate the number of elements in the original dataset, and two sketches can be merged with a quick operation to obtain the sketch of the union of two datasets. However, the non-private sketch reveals information about what individuals may or may not be in the dataset.

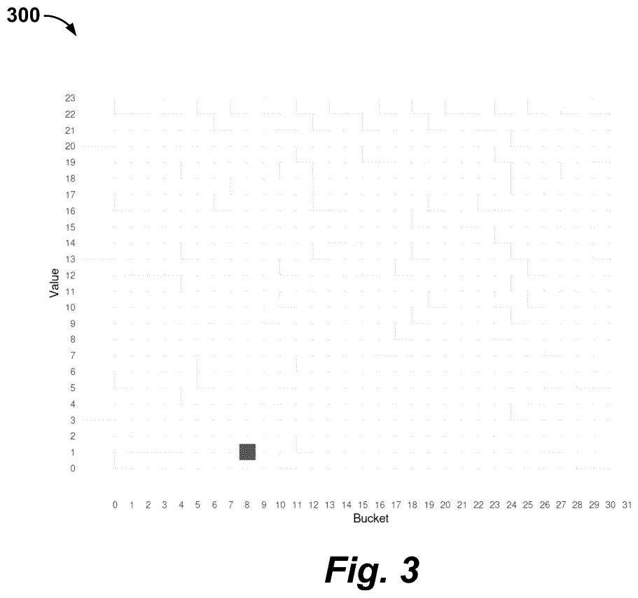

A PCSA sketch comprises a non-private matrix of bits. Creating a new PCSA sketch comprises creating a B×P matrix of zeros. FIG. 3 illustrates an exemplary PCSA sketch 300 with a B×P matrix of bits, where B is the number of buckets, and P is a measure of precision. In this illustrative example, B=32 and P=24. However, in practice, B is typically a much larger number (e.g., 4096 or higher). When a new item is added to the sketch, some of the information associated with the new item is passed through a hash function. For example, when a user 102 in FIG. 1 clicks on an advertisement, an event is sent to the advertisement system 106. Advertisement system 106 may send a command to private distinct-counting sketching system 108 with different information, including the campaign ID, the received date of the event from user 102, and the user ID associated with user 102, to indicate to private distinct-counting sketching system 108 that user 102 has viewed the advertisement of the campaign. At least some of the information received by private distinct-count sketching system 108 may be passed to a hash function to generate a hash value. The hash function maps any given item to a hash value, which is a sequence of seemingly random Os and Is. For example, the sequence is 01000|0100101010101101011001011010110110010110. The left-most log 2(B) bits of the sequence is used to determine which bucket the item maps to. In this example, log 2(32)=5, and the leading 5 bits are 01000, i.e., 8 in decimal. Therefore, the bucket that the new item is mapped to is 8.

Next, the position of the first one-bit in the remaining portion of the hash value that is after the leading bits is determined. In this case, the rest of the hash value is 0100101 . . . , which has a 1 in the second position. Therefore, the element [8, 1] is set to 1, where 8 in [8, 1] is the bucket, 1 in [8, 1] is the position of the first one-bit, and the element [8, 1] is set to 1 to indicate that the item/hash has been observed at least once. In other words, an item in a dataset is inserted into the sketch by setting a bit of the sketch to a one-bit based on the hash function.

Because PCSA sketch 300 only records unique entries, PCSA sketch 300 will not be updated if the same item is added again. In other words, setting element [8, 1] to 1 a second time has no effect. On the other hand, if another new added item has a different hash value that starts with the same six bits, PCSA sketch 300 will also not be updated as well. For example, another new item has a different hash value of 01000010000000 . . . , but since the leading 5 bits are 01000, the new item also maps to the element [8, 1]. This is due to the compressive nature of PCSA sketch 300. In PCSA sketch 300, there are 32×24=768 bits in the matrix, but the sketch is used to track potentially large cardinalities.

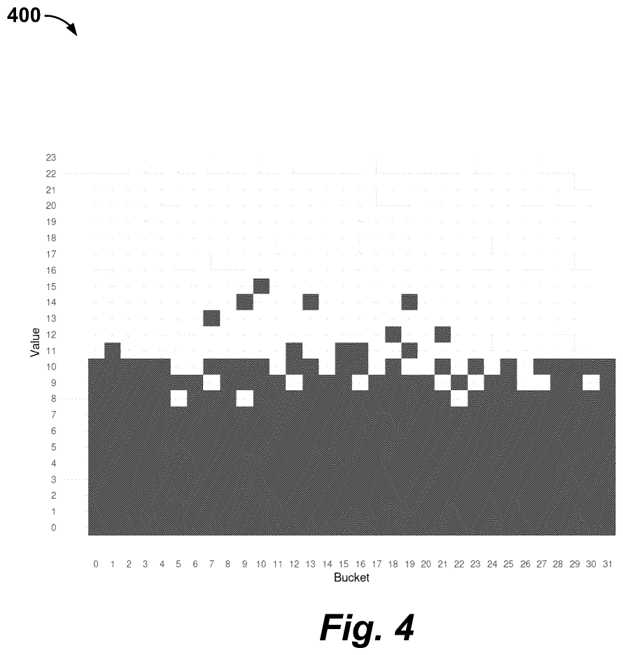

FIG. 4 illustrates an exemplary PCSA sketch 400 after 50,000 unique items have been added to PCSA sketch 300. As shown in FIG. 4, despite the compressive nature of PCSA sketch 300, after many items are added, the matrix starts to fill in. In particular, the lower values tend to fill in first. The reason is because a hash value is much more likely to have its first one-bit position at the beginning portion of the sequence than at the portions of the sequence that are further behind. For example, in a 32-bit hash, there is only one hash value whose first one-bit is in the last position (000 . . . 0001), but there are over two billion hash values that have a first one-bit in the first position. As shown in FIG. 4, most bits in the matrix are filled in for value <=10, and most bits are still zero for value >10. The top-level is around the value of 10. Intuitively, as more items are added to the sketch, more matrix elements with a higher value will be filled, and how many total unique items have been added to the sketch may be estimated based on how full the matrix is.

However, PCSA sketches are not anonymous sketches. For example, with reference to PCSA sketch 300 with only one added item, a person who observes this sketch will be informed that the sketch only has items that hash to values starting with 0100001. In other words, the person is informed that any item that has a hash that starts differently (which is the overwhelming majority of all possible items) is definitely not represented in the sketch. Moreover, a partial record of the hash value (i.e., 0100001) corresponding to the only item that is represented in the sketch is also revealed.

With reference to FIG. 2, at step 204, the non-private probabilistic cardinality estimator for the first dataset is converted to a private probabilistic cardinality estimator, thereby preserving privacy. In some embodiments, noise is added by randomly flipping the bits in PCSA sketch 400. Randomly flipping the bits makes it no longer clear which bits are “true” and which bits are “noise,” thereby making it difficult to determine which users are actually included in the summary dataset. As a result, the non-private PCSA sketch 400 is converted to a noisy sketch that preserves privacy.

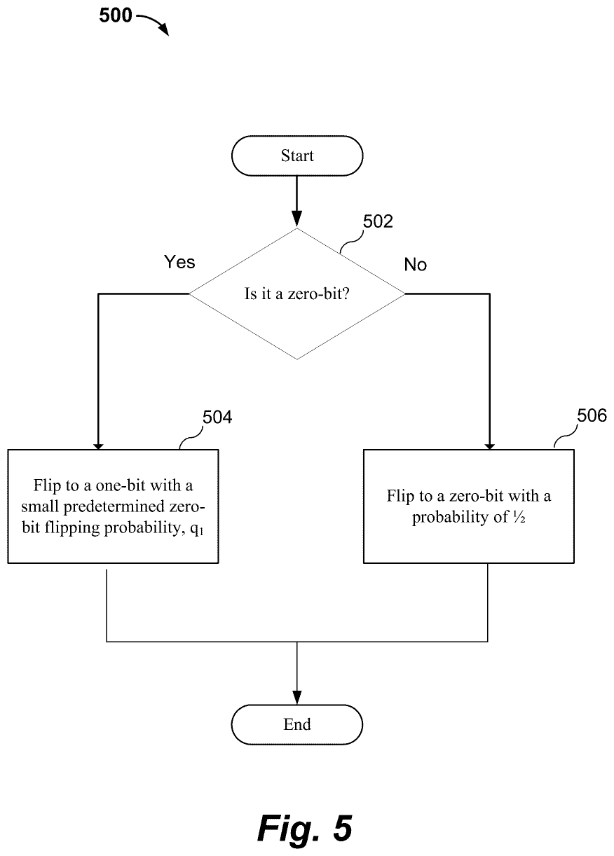

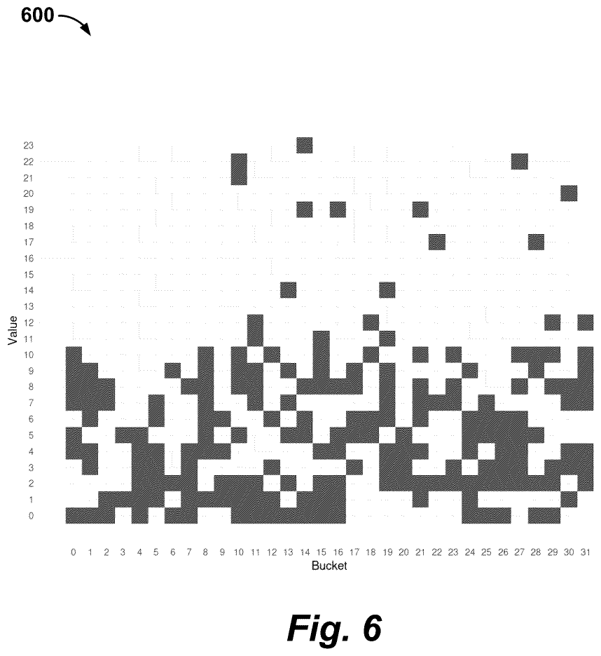

Different techniques may be used to randomly change the bits in the non-private sketch. In some embodiments, the randomized response is referred to as the deterministic-merge randomized response. FIG. 5 illustrates an exemplary process 500 for randomizing the non-private probabilistic cardinality estimator using a deterministic-merge randomized response. In some embodiments, process 500 is executed for some or all of the bits in the non-private sketch. At step 502, it is determined whether the current bit is a zero-bit. If the current bit is a zero-bit, then process 500 proceeds to step 504, otherwise process 500 proceeds to step 506. At step 504, the zero-bit is flipped to a one-bit with a small predetermined zero-bit flipping probability, q₁. For example, q₁ may be a predetermined probability of 5% or less, which is based on a level of desired privacy. The small predetermined zero-bit flipping probability q₁ is indicative of a noise level added to the non-private sketch. This is because the higher the probability that a bit is flipped in its value, the more noise that is introduced. At step 506, the one-bit is flipped to a zero-bit with a probability of ½. As a result, a small amount of randomness will be added to the top of the sketch with higher values, and about half of the bits from the bottom of the sketch will disappear. FIG. 6 illustrates an exemplary private sketch 600 after randomization of the PCSA sketch 400 using the deterministic-merge randomized response with q₁=2.5%. The top-level is around the value of 10, but about half of the information from this sketch has been removed, which is suboptimal.

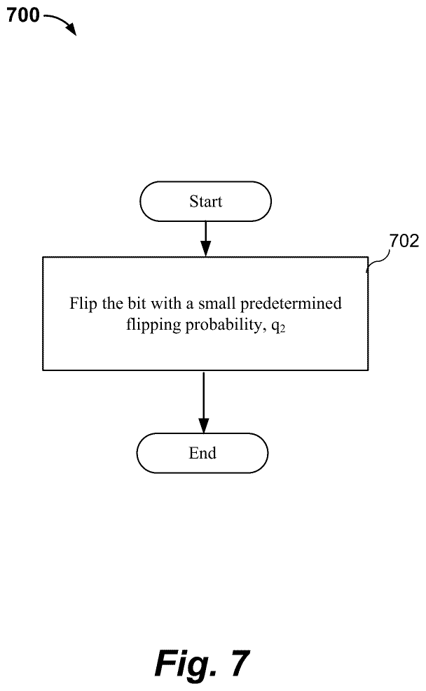

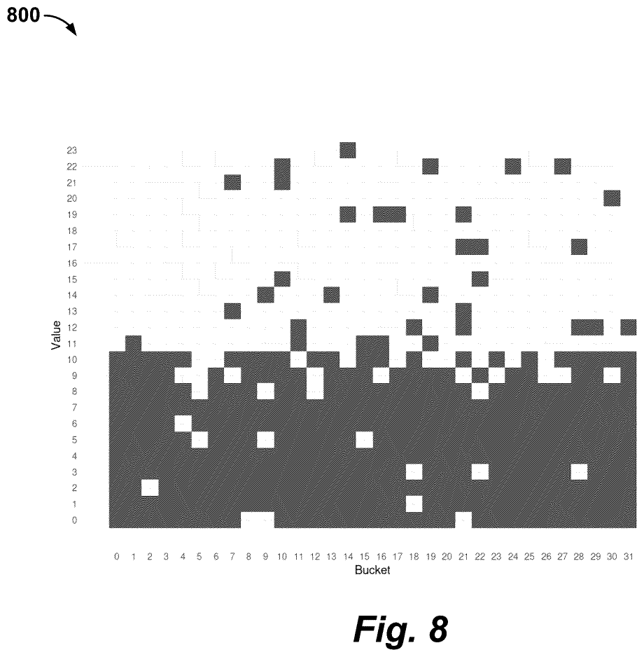

In some other embodiments, the randomized response that is used to randomly change the bits in the non-private sketch is referred to as the randomized-merge. FIG. 7 illustrates an exemplary process 700 for randomizing the non-private probabilistic cardinality estimator using a randomized-merge response. In some embodiments, process 700 is executed for some or all of the bits in the non-private sketch. At step 702, any bit is flipped with the same small predetermined flipping probability q₂. For example, a zero-bit is flipped to a one-bit with a small predetermined flipping probability, q₂. Similarly, a one-bit is flipped to a zero-bit with the small predetermined flipping probability, q₂. In some embodiments, the small predetermined flipping probability q₂ is 5% or less, which is based on a level of desired privacy. The small predetermined flipping probability q₂ is indicative of a noise level added to the non-private sketch. The small predetermined flipping probability corresponds to the noise level. This is because the higher the probability that a bit is flipped in its value, the more noise is introduced. FIG. 8 illustrates an exemplary private sketch 800 after randomization of all bits of the PCSA sketch 400 using the randomized-merge response with q₂=4.7%. In terms of a differential privacy guarantee, this sketch provides the same level of privacy as the one shown in FIG. 6 (using the deterministic-merge randomized response), but the overall picture is much clearer, since much less information is removed from the bottom of the sketch.

Referring to FIG. 2, at step 206 of process 200, the private probabilistic cardinality estimator for the first dataset is merged with one or more other probabilistic cardinality estimators, each corresponding to one or more other datasets, to produce a merged probabilistic cardinality estimator for the combined datasets. The one or more other probabilistic cardinality estimators may be non-private or private estimators. For example, for a non-private probabilistic cardinality estimator, its corresponding small predetermined flipping probability is zero and the added noise level is zero. The resulting merged sketch should be substantially equivalent to having performed steps 202 and 204 of process 200 over the combined dataset.

Merging private sketches is a very different operation from merging non-private sketches. Two non-private PCSA sketches can be merged by simply taking the bitwise OR of the two PCSA sketches. For example, given two matrices, if there is a one-bit in either of the two matrices in the same corresponding position, then the merged result is a one-bit. This is functionally equivalent to having created a single sketch over the combined datasets. In particular, any given bit in the merged sketch will be set to 1 if and only if there is an appropriate item that hashes to that bit in either of the datasets.

Different techniques are used to merge a sketch that has been randomized using the deterministic-merge randomized response and one that has been randomized using the randomized-merge response. For the sketch that has been randomized using the deterministic-merge randomized response, the merge is a simple deterministic operation. For the sketch that has been randomized using the randomized-merge response, the merge is a more complex randomized operation, as will be described below.

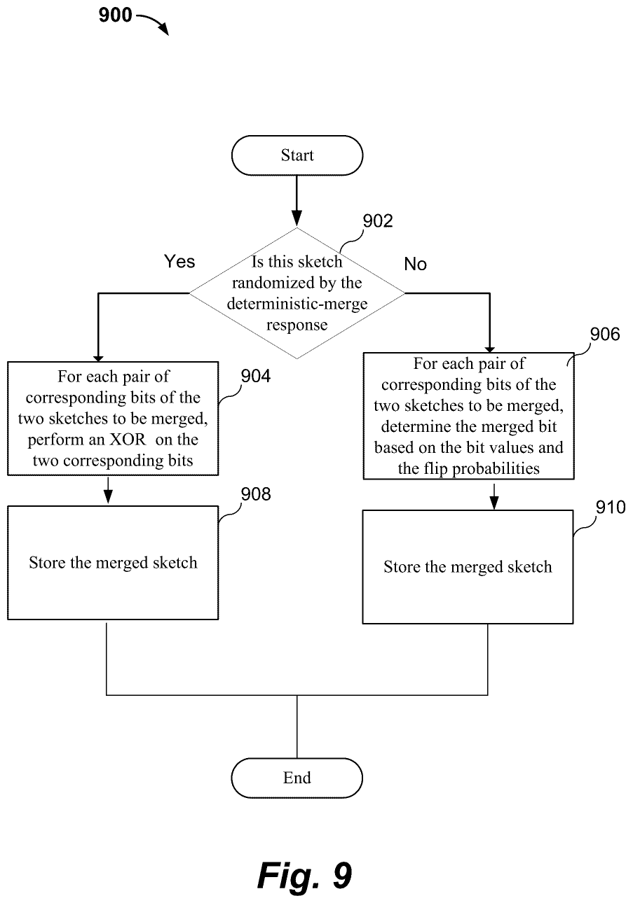

FIG. 9 illustrates an exemplary process 900 for merging a private sketch for a first dataset with another private sketch to produce a merged sketch for the combined datasets. In some embodiments, process 900 is performed at step 206 of process 200. At step 902, it is determined whether the two sketches to be merged together are sketches that have been randomized using the deterministic-merge randomized response. If the two sketches to be merged together are sketches that have been randomized using the deterministic-merge randomized response, then process 900 proceeds to step 904, else process 900 proceeds to step 906.

At step 904, two sketches that have been randomized using the deterministic-merge randomized response are merged by performing an XOR operation on the two sketches. After step 904 is performed, process 900 proceeds to step 908. At step 908, the merged sketch is stored. At step 904, for each pair of corresponding bits of the two sketches to be merged, perform an exclusive or (XOR) operation on the two corresponding bits. For example, given two sketches, if only one of the bits (but not both bits) in the same corresponding position has a value of one, then the merged result bit is a one-bit. Mathematically, the XOR operation is as follows:

$$randomize 1 ( x , {q}_{1 x} ) XOR randomize 1 ( y , {q}_{1 y} = randomize 1 ( x OR y , {q}_{1 xy} )$$

where x and y are two corresponding bits of two sketches X and Y, q₁ₓ and q_{1y} denote the flipping probabilities used to privatize bits x and y (respectively), and q_{1xy} is a function of q₁ₓ and q_{1y}.

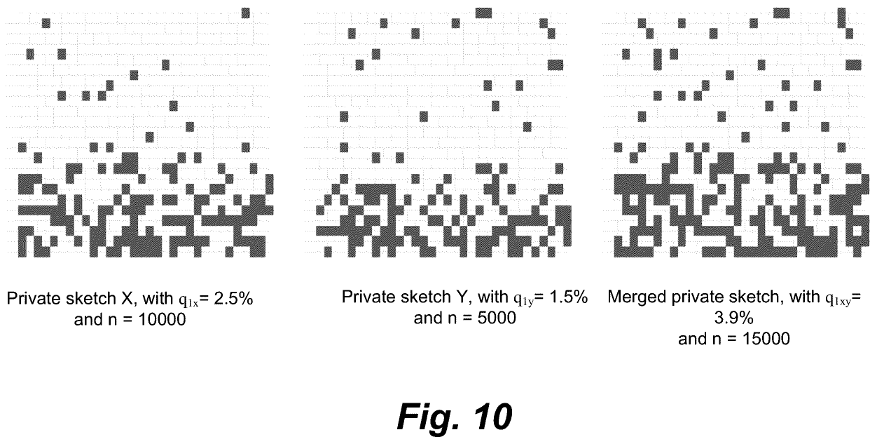

FIG. 10 illustrates an example of merging two private sketches that have been randomized using the deterministic-merge randomized response to produce a merged private sketch. On the left is a private sketch X that has been randomized using the deterministic-merge randomized response with q₁ₓ, and the number of items in the private sketch X is n=10000. In the middle is a private sketch Y that has been randomized using the deterministic-merge randomized response with q_{1y}, and the number of items in the private sketch Y is n=5000. On the right is a merged private sketch with q_{1xy}, and the number of items in the merged private sketch is n=15000. Note that the merged sketch on the right side is noisier than either of the individual sketches before the merge.

For two sketches that have been randomized using the randomized-merge response, they cannot be merged with any simple (deterministic) operation. At step 906, the two sketches are merged by performing a randomized merge operation on the two sketches. After step 906 is performed, process 900 proceeds to step 910. At step 910, the merged sketch is stored.

Suppose that x and y are two corresponding bits of two sketches X and Y, q₂ₓ and q_{2y} are the small predetermined flipping probabilities used to privatize bits x and y (respectively), a random value to represent the merged bit merge(x, y) is determined based on the values of x and y and the flipping probabilities q₂ₓ and q_{2y}, which indicate the noise levels of sketches X and Y, respectively. At step 906, for each pair of corresponding bits of the two sketches to be merged, determine the merged bit based on the bit values (x and y) and the flip probabilities q₂ₓ and q_{2y}.

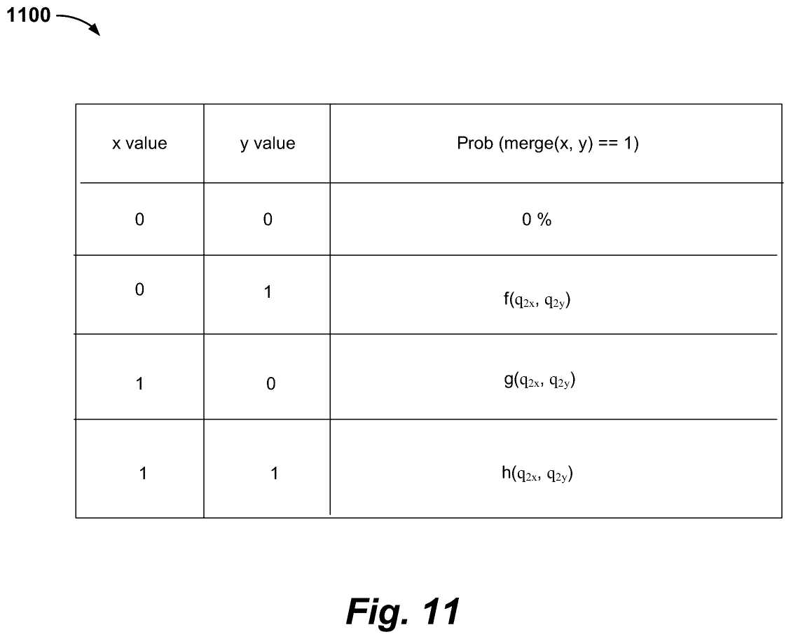

FIG. 11 illustrates an exemplary table 1100 for determining the merged bits of two private sketches (X and Y) that have been randomized using the randomized-merge response. When bit x of sketch X is 0 and bit y of sketch Y is 0, the probability of merge(x, y) being equal to 1 (i.e., Prob (merge(x, y)==1)) is zero. For this combination of bit x and bit y values, the probability of setting a bit on the merged sketch is deterministic as the probability is always zero. When bit x is 0 and bit y is 1, Prob (merge(x, y)==1) is a probability function (f) of q₂ₓ and q_{2y}. In other words, the function f takes the noise levels of sketch X and sketch Y (q₂ₓ and q_{2y}) and provides a probability that is used to set a random bit on the merged sketch. When bit x is 1 and bit y is 0, Prob (merge(x, y)==1) is a probability function (g) of q₂ₓ and q_{2y}. When bit x is 1 and bit y is 1, Prob (merge(x, y)==1) is a probability function (h) of q₂ₓ and q_{2y}. Since a different probability function is used for each combination of x and y values for determining the probability used to set a bit on the merged sketch, the merged bit is based on the bit values (x and y) and the noise levels of the two sketches. In particular, a bit of the merged sketch is set to a one-bit based on a probability function that is based on a bit value of a corresponding bit of the first private sketch X, a bit value of a corresponding bit of the second private sketch Y, the small predetermined flipping probabilities corresponding to sketch X, and the small predetermined flipping probabilities corresponding to sketch Y.

Using the above randomization plan to merge x and y, the merged bits satisfy the following property (where q_{2xy} is a function of q₂ₓ and q_{2y}):

$$merge ( randomize 2 ( x , {q}_{2 x} ) , randomize 2 ( y , {q}_{2 y} ) ) = randomize 2 ( x OR y , {q}_{2 x y} )$$

where x and y are two corresponding bits of the two sketches X and Y, q₂ₓ and q_{2y} denote the flipping probabilities used to privatize bits x and y (respectively), and q_{2xy} is a function of q₂ₓ and q_{2y}.

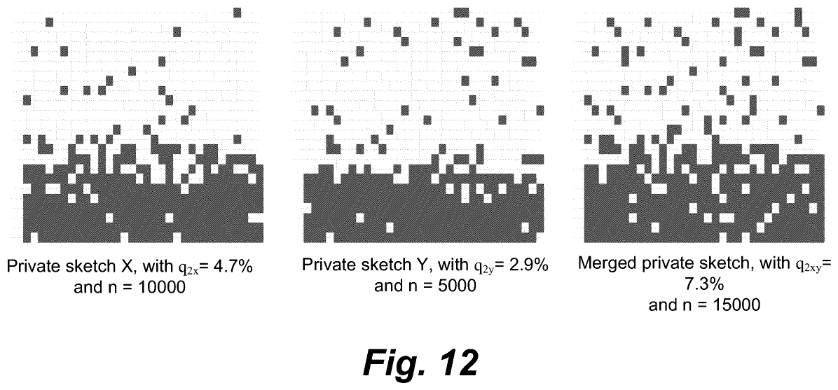

FIG. 12 illustrates an example of merging two private sketches that have been randomized using the randomized-merge response to produce a merged private sketch. On the left is a private sketch X that has been randomized using the randomized-merge response with q₂ₓ, and the number of items in the private sketch X is n=10000. In the middle is a private sketch Y that has been randomized using the randomized-merge response with q_{2y}, and the number of items in the private sketch Y is n=5000. On the right is a merged private sketch with q_{2xy}, and the number of items in the merged private sketch is n=15000. Note that the overall noise level of the merged sketch on the right side is higher than either of the individual sketches before the merge.

Referring to FIG. 2, at step 208, the number of unique elements in the combined datasets are estimated based on the merged probabilistic cardinality estimator for the combined datasets. In some embodiments, a composite likelihood-based cardinality estimator that is consistent and asymptotically optimal is used. While a true maximum likelihood estimation of n given a sketch is computationally infeasible, due to the non-independence of bits in the sketch, the marginal likelihood for any bit can be found. In some embodiments, a composite marginal likelihood estimator for n may be used to estimate the number of unique elements in the combined datasets.

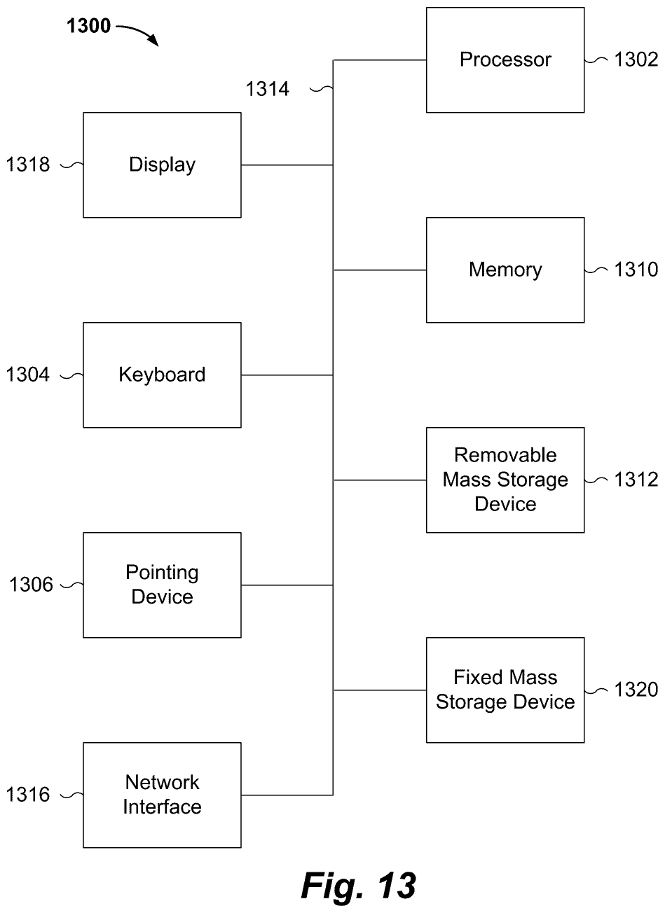

FIG. 13 is a functional diagram illustrating a programmed computer system for executing some of the processes in accordance with some embodiments. As will be apparent, other computer system architectures and configurations can be used as well. Computer system 1300, which includes various subsystems as described below, includes at least one microprocessor subsystem (also referred to as a processor or a central processing unit (CPU)) 1302. For example, processor 1302 can be implemented by a single-chip processor or by multiple processors. In some embodiments, processor 1302 is a general purpose digital processor that controls the operation of the computer system 1300. Using instructions retrieved from memory 1310, the processor 1302 controls the reception and manipulation of input data, and the output and display of data on output devices (e.g., display 1318). In some embodiments, processor 1302 includes and/or is used to execute/perform processes 200, 500, 700, and 900 described above with respect to FIGS. 2, 5, 7, and 9.

Processor 1302 is coupled bi-directionally with memory 1310, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1302. Also as is well known in the art, primary storage typically includes basic operating instructions, program code, data and objects used by the processor 1302 to perform its functions (e.g., programmed instructions). For example, memory 1310 can include any suitable computer-readable storage media, described below, depending on whether, for example, data access needs to be bi-directional or uni-directional. For example, processor 1302 can also directly and very rapidly retrieve and store frequently needed data in a cache memory (not shown).

A removable mass storage device 1312 provides additional data storage capacity for the computer system 1300, and is coupled either bi-directionally (read/write) or uni-directionally (read only) to processor 1302. For example, storage 1312 can also include computer-readable media such as magnetic tape, flash memory, PC-CARDS, portable mass storage devices, holographic storage devices, and other storage devices. A fixed mass storage 1320 can also, for example, provide additional data storage capacity. The most common example of mass storage 1320 is a hard disk drive. Mass storages 1312, 1320 generally store additional programming instructions, data, and the like that typically are not in active use by the processor 1302. It will be appreciated that the information retained within mass storages 1312 and 1320 can be incorporated, if needed, in standard fashion as part of memory 1310 (e.g., RAM) as virtual memory.

In addition to providing processor 1302 access to storage subsystems, bus 1314 can also be used to provide access to other subsystems and devices. As shown, these can include a display monitor 1318, a network interface 1316, a keyboard 1304, and a pointing device 1306, as well as an auxiliary input/output device interface, a sound card, speakers, and other subsystems as needed. For example, the pointing device 1306 can be a mouse, stylus, track ball, or tablet, and is useful for interacting with a graphical user interface.

The network interface 1316 allows processor 1302 to be coupled to another computer, computer network, or telecommunications network using a network connection as shown. For example, through the network interface 1316, the processor 1302 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1302 can be used to connect the computer system 1300 to an external network and transfer data according to standard protocols. For example, various process embodiments disclosed herein can be executed on processor 1302, or can be performed across a network such as the Internet, intranet networks, or local area networks, in conjunction with a remote processor that shares a portion of the processing. Additional mass storage devices (not shown) can also be connected to processor 1302 through network interface 1316.

An auxiliary I/O device interface (not shown) can be used in conjunction with computer system 1300. The auxiliary I/O device interface can include general and customized interfaces that allow the processor 1302 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 13 is but an example of a computer system suitable for use with the various embodiments disclosed herein. Other computer systems suitable for such use can include additional or fewer subsystems. In addition, bus 1314 is illustrative of any interconnection scheme serving to link the subsystems. Other computer architectures having different configurations of subsystems can also be utilized.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A system, comprising:
a processor configured to:
determine a first non-private probabilistic cardinality estimator for a first dataset;
convert the first non-private probabilistic cardinality estimator to a first private probabilistic cardinality estimator for the first dataset with a first noise level;
merge the first private probabilistic cardinality estimator for the first dataset with a second probabilistic cardinality estimator for a second dataset with a second noise level to produce a merged probabilistic cardinality estimator for the first dataset and the second dataset combined together based at least in part on the first noise level and the second noise level; and
estimate a number of unique elements in the first dataset and the second dataset combined together based on the merged probabilistic cardinality estimator for the first dataset and the second dataset combined together; and
a memory coupled to the processor and configured to provide the processor with instructions.

2. The system of claim 1, wherein the first non-private probabilistic cardinality estimator comprises a first non-private matrix of bits, and wherein the processor is further configured to: insert an item in the first dataset by setting a bit of the first non-private matrix of bits to a one-bit based on a hash function.

3. The system of claim 2, wherein the first non-private probabilistic cardinality estimator comprises a first probabilistic counting with stochastic averaging (PCSA) sketch.

4. The system of claim 2, wherein the processor is further configured to, for at least some bits in the first non-private matrix of bits:
flip a bit that is a one-bit in the first non-private matrix of bits based on a first predetermined flipping probability and flip a bit that is a zero-bit in the first non-private matrix of bits based on the first predetermined flipping probability to convert the first non-private probabilistic cardinality estimator to the first private probabilistic cardinality estimator with the first noise level, wherein the first predetermined flipping probability corresponds to the first noise level, and wherein the first private probabilistic cardinality estimator comprises a first private matrix of bits.

5. The system of claim 4, wherein the first predetermined flipping probability is based on a level of desired privacy.

6. The system of claim 4, wherein in the event that the second probabilistic cardinality estimator is non-private:
a second predetermined flipping probability is set to zero, and wherein the second predetermined flipping probability corresponds to the second noise level, and wherein in the event that the second probabilistic cardinality estimator is private:
the second probabilistic cardinality estimator is converted from a second non-private probabilistic cardinality estimator comprising a second non-private matrix of bits, wherein for at least some bits in the second non-private matrix of bits:
a bit that is a one-bit in the second non-private matrix of bits is flipped based on a second predetermined flipping probability and a bit that is a zero-bit in the second non-private matrix of bits is flipped based on the second predetermined flipping probability to convert the second non-private probabilistic cardinality estimator to the second probabilistic cardinality estimator with the second noise level, wherein the second predetermined flipping probability corresponds to the second noise level.

7. The system of claim 6, wherein the merged probabilistic cardinality estimator comprises a merged matrix of bits, and wherein the processor is further configured to, for at least some of the merged matrix of bits:
set a bit to a one-bit based on a probability function that is based on a bit value of a corresponding bit of the first private probabilistic cardinality estimator, a bit value of a corresponding bit of the second probabilistic cardinality estimator, the first predetermined flipping probability, and the second predetermined flipping probability.

8. The system of claim 7, wherein the processor is further configured to, for at least some of the merged matrix of bits: set a bit to a zero-bit in response to a bit value of a corresponding bit of the first private probabilistic cardinality estimator being equal to zero and a bit value of a corresponding bit of the second probabilistic cardinality estimator being equal to zero.

9. A method, comprising:
determining a first non-private probabilistic cardinality estimator for a first dataset;
converting the first non-private probabilistic cardinality estimator to a first private probabilistic cardinality estimator for the first dataset with a first noise level;
merging the first private probabilistic cardinality estimator for the first dataset with a second probabilistic cardinality estimator for a second dataset with a second noise level to produce a merged probabilistic cardinality estimator for the first dataset and the second dataset combined together based at least in part on the first noise level and the second noise level; and
estimating a number of unique elements in the first dataset and the second dataset combined together based on the merged probabilistic cardinality estimator for the first dataset and the second dataset combined together.

10. The method of claim 9, wherein the first non-private probabilistic cardinality estimator comprises a first non-private matrix of bits, further comprising: inserting an item in the first dataset by setting a bit of the first non-private matrix of bits to a one-bit based on a hash function.

11. The method of claim 10, wherein the first non-private probabilistic cardinality estimator comprises a first probabilistic counting with stochastic averaging (PCSA) sketch.

12. The method of claim 10, further comprising: for at least some bits in the first non-private matrix of bits:
flipping a bit that is a one-bit in the first non-private matrix of bits based on a first predetermined flipping probability and flipping a bit that is a zero-bit in the first non-private matrix of bits based on the first predetermined flipping probability to convert the first non-private probabilistic cardinality estimator to the first private probabilistic cardinality estimator with the first noise level, wherein the first predetermined flipping probability corresponds to the first noise level, and wherein the first private probabilistic cardinality estimator comprises a first private matrix of bits.

13. The method of claim 12, wherein the first predetermined flipping probability is based on a level of desired privacy.

14. The method of claim 12, wherein in the event that the second probabilistic cardinality estimator is non-private:
a second predetermined flipping probability is set to zero, and wherein the second predetermined flipping probability corresponds to the second noise level, and wherein in the event that the second probabilistic cardinality estimator is private:
the second probabilistic cardinality estimator is converted from a second non-private probabilistic cardinality estimator comprising a second non-private matrix of bits, wherein for at least some bits in the second non-private matrix of bits:
a bit that is a one-bit in the second non-private matrix of bits is flipped based on a second predetermined flipping probability and a bit that is a zero-bit in the second non-private matrix of bits is flipped based on the second predetermined flipping probability to convert the second non-private probabilistic cardinality estimator to the second probabilistic cardinality estimator with the second noise level, wherein the second predetermined flipping probability corresponds to the second noise level.

15. The method of claim 14, wherein the merged probabilistic cardinality estimator comprises a merged matrix of bits, further comprising, for at least some of the merged matrix of bits:
setting a bit to a one-bit based on a probability function that is based on a bit value of a corresponding bit of the first private probabilistic cardinality estimator, a bit value of a corresponding bit of the second probabilistic cardinality estimator, the first predetermined flipping probability, and the second predetermined flipping probability.

16. The method of claim 15, further comprising, for at least some of the merged matrix of bits:
setting a bit to a zero-bit in response to a bit value of a corresponding bit of the first private probabilistic cardinality estimator being equal to zero and a bit value of a corresponding bit of the second probabilistic cardinality estimator being equal to zero.

17. A computer program product embodied in a non-transitory computer readable medium and comprising computer instructions for:
determining a first non-private probabilistic cardinality estimator for a first dataset;
converting the first non-private probabilistic cardinality estimator to a first private probabilistic cardinality estimator for the first dataset with a first noise level;
merging the first private probabilistic cardinality estimator for the first dataset with a second probabilistic cardinality estimator for a second dataset with a second noise level to produce a merged probabilistic cardinality estimator for the first dataset and the second dataset combined together based at least in part on the first noise level and the second noise level; and
estimating a number of unique elements in the first dataset and the second dataset combined together based on the merged probabilistic cardinality estimator for the first dataset and the second dataset combined together.

18. The computer program product of claim 17, wherein the first non-private probabilistic cardinality estimator comprises a first non-private matrix of bits, further comprising: inserting an item in the first dataset by setting a bit of the first non-private matrix of bits to a one-bit based on a hash function.

19. The computer program product of claim 18, further comprising computer instructions for, for at least some bits in the first non-private matrix of bits:
flipping a bit that is a one-bit in the first non-private matrix of bits based on a first predetermined flipping probability and flipping a bit that is a zero-bit in the first non-private matrix of bits based on the first predetermined flipping probability to convert the first non-private probabilistic cardinality estimator to the first private probabilistic cardinality estimator with the first noise level, wherein the first predetermined flipping probability corresponds to the first noise level, and wherein the first private probabilistic cardinality estimator comprises a first private matrix of bits.

20. The computer program product of claim 19, wherein the merged probabilistic cardinality estimator comprises a merged matrix of bits, further comprising computer instructions for, for at least some of the merged matrix of bits:
setting a bit to a one-bit based on a probability function that is based on a bit value of a corresponding bit of the first private probabilistic cardinality estimator, a bit value of a corresponding bit of the second probabilistic cardinality estimator, the first predetermined flipping probability, and a second predetermined flipping probability.
